(19) United States
(12) Patent Application Publication
(10) Pub. No.: US 2011/0101841 A1
(43) Pub. Date: May 5, 2011

(54) LED lamp

(76) Inventor: Yue Qin, Foshan (CN)

(21) Appl. No.: 12/611,007

(22) Filed: Nov. 2, 2009

(51) Int. Cl. H01J 61/52

(52) U.S. Cl. 313/46

(57) ABSTRACT

A LED lamp includes a lamp cap, a body case, a power unit, a bulb shell and a connecting member. The power unit includes a driving printed circuit board designed to be a Class 2 isolation driving power, a metal core printed circuit board electrically connected with the driving printed circuit board; and at least one LED provided on and electrically connected with the metal core printed circuit board, in such a manner that, commercial power input by the lamp cap is transformed into a working current and voltage of the LED by the driving printed circuit board so that the LED is driven to work. The bulb shell is made of glass material. The connecting member can be made of glue, silica gel, PC/PBT and other plastic materials. The bulb shell is fittingly and shapedly engaged with the other end of the body case by the connecting member.

### BACKGROUND OF THE PRESENT INVENTION

1. Field of Invention

The present invention relates to an illuminating device, and more particularly to a LED (light emitting diode) lamp.

2. Description of Related Arts

Light-emitting diode (LED), as an emerging high-technology lamp at this stage, compared with other lamps, has a good stable performance, compact size and long life. The most important is that it has less energy consumption, higher brightness, green environmental protection, shorter response time, but unlike the incandescent lamp with a high calorific value at work. Accordingly, it is the most ideal choice for LED to be used to illuminate. Furthermore, LED is a highly efficient cold light source.

Traditional bulb shell of LED lamp, made of plastic material, has following shortcomings. Firstly, molding die of the plastic bulb shell has a higher cost, and own parts of the plastic bulb shell also have higher costs. Secondly, the plastic bulb shell has a relatively lower light transmission rate. Thirdly, the plastic bulb shell is easy to turn yellow and aging after long-term use, specifically, the yellowing will affect the light transmission performance, the aging will lead to the fragility, thus the plastic bulb shell can not meet the requirement of long life for the LED lamp. In addition, for the LED bulb shell made of glass material, if the power supply of the LED lamp is not designed to be the Class 2 isolation driving power, and the LED lamp is damaged during the UL impact test, the internal live parts (can not be considered at a safe voltage) will be touched, thus the human body is at risk.

### SUMMARY OF THE PRESENT INVENTION

An object of the present invention is to provide a LED lamp comprising a Class 2 isolation driving power and a metal core printed circuit board (MCPCB), wherein live parts on the metal core printed circuit board, which are capable of being touched, are low-voltage components so that the security problem caused by glass bulb shell burst during the UL impact test is solved.

Another object of the present invention is to provide a LED lamp comprising a bulb shell made of glass material, which not only has a higher light transmission rate, and is difficult to turn yellow and aging, but also meets the requirement of fire-resistant level on the U.S. market.

Another object of the present invention is to provide a LED lamp which is capable of avoiding the glass bulb shell burst caused by different expansion rates while glass combines with metal.

Another object of the present invention is to provide a LED lamp with low cost and simple structure.

Accordingly, in order to accomplish the above objects, the present invention provides a LED lamp, comprising:

a lamp cap,

a body case, comprising:
a housing, an end portion of which is coaxially provided within the lamp cap,
a housing cover; and
a heat dissipation member, an end of which is connected with the housing cover for forming a whole to be coaxially provided outside the housing and connected with the lamp cap;

a power unit comprising:
a driving printed circuit board provided within the housing and designed to be a Class 2 isolation driving power,
a metal core printed circuit board provided within the heat dissipation member and electrically connected with the driving printed circuit board; and
at least one LED provided on and electrically connected with the metal core printed circuit board, in such a manner that, commercial power input by the lamp cap is transformed into a working current and voltage of the LED by the driving printed circuit board so that the LED is driven to work; and

a bulb shell fittingly and shapedly engaged with the other end of the heat dissipation member.

These and other objectives, features, and advantages of the present invention will become apparent from the following detailed description, the accompanying drawings, and the appended claims.

### BRIEF DESCRIPTION OF THE DRAWINGS

FIG. 1 is a side view of a LED lamp of the present invention.

FIG. 2 is an exploded view of the LED lamp according to a first preferred embodiment of the present invention.

FIG. 3 is an exploded view of the LED lamp according to a second preferred embodiment of the present invention.

### DETAILED DESCRIPTION OF THE PREFERRED EMBODIMENT

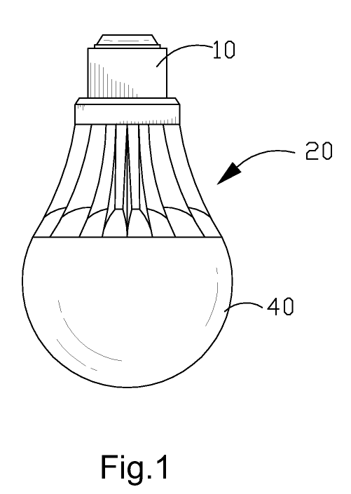

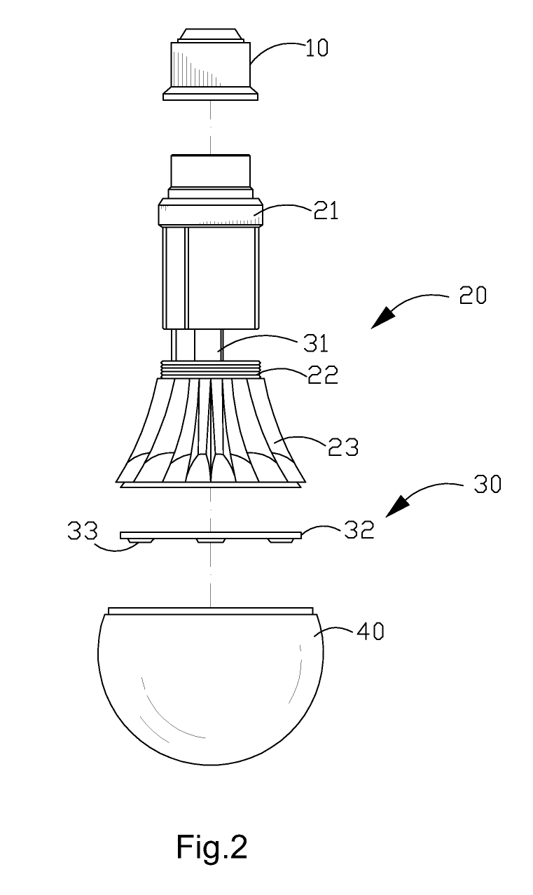

Referring to FIGS. 1 and 2 of the drawings, a LED lamp according to a first preferred embodiment of the present invention is illustrated, in which the LED lamp comprises a lamp cap 10, a body case 20, a power unit 30 and a bulb shell 40.

The body case 20 comprises a housing 21, a housing cover 22 and a heat dissipation member 23. An end portion of the housing 21 is coaxially provided within the lamp cap 10. The housing cover 22 is connected with an end of the heat dissipation member 23 for forming a whole to be coaxially provided outside the housing 21 and connected with the lamp cap 10. Here, the LED not only produces a lot of heat at work, but also is a temperature-sensitive component, once the temperature is in excess of node temperature, the LED will die quickly, so the heat dissipation member 23 is made of materials with good heat dissipation performance (such as aluminum, copper and plastic).

The power unit 30 comprises a driving printed circuit board 31 provided within the housing 21, a metal core printed circuit board (MCPCB) 32 provided within the heat dissipation member 23, and at least one light emitting diode (LED) 33 provided on the metal core printed circuit board 32, wherein the driving printed circuit board 31 is electrically connected with the metal core printed circuit board 32, the LED 33 is electrically connected with the metal core printed circuit board 32, in such a manner that, commercial power input by the lamp cap 10 (120V 60 Hz in U.S.) is transformed into the working current and voltage of the LED 33 by the driving printed circuit board 31, so that the LED 33 is driven to work, wherein the working voltage of the LED is 3.0-3.8VDC.

The bulb shell 40 is fittingly and shapedly engaged with the other end of the heat dissipation member 23, wherein the bulb shell 40 is made of metal material.

Here, the driving printed circuit board 31 is designed to be a Class 2 isolation driving power.

It is worth to mention that, when the power supply of the LED lamp is the Class 2 isolation driving power, the live parts such as LED 33 are safe low-voltage components. Accordingly, the components, which are capable of being touched, are isolated low-voltage (namely safe voltage) components even if the LED lamp is damaged.

Furthermore, both the lamp cap 10 and the bulb shell 40 are inherent traditional parts of all LED lamps.

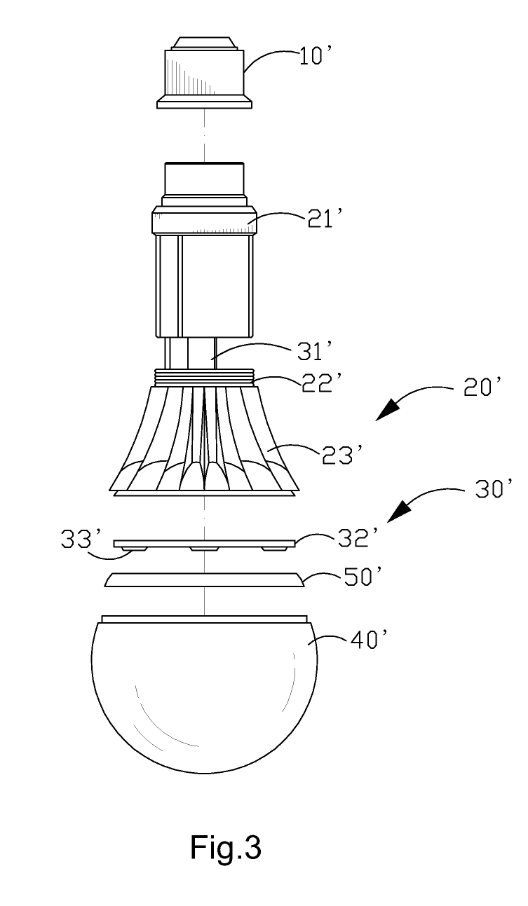

FIG. 3 illustrates the LED lamp according to a second preferred embodiment of the present invention.

The LED lamp comprises a lamp cap 10′, a body case 20′, a power unit 30′ and a bulb shell 40′.

Like the above first preferred embodiment, the body case 20′ comprises a housing 21′, a housing cover 22′ and a heat dissipation member 23′. An end portion of the housing 21′ is coaxially provided within the lamp cap 10′. The housing cover 22′ is connected with an end of the heat dissipation member 23′ for forming a whole to be coaxially provided outside the housing 21′ and connected with the lamp cap 10′. Here, the LED not only produces a lot of heat at work, but also is a temperature-sensitive component, once the temperature is in excess of node temperature, the LED will die quickly, so the heat dissipation member 23′ is made of materials with good heat dissipation performance (such as aluminum, copper and plastic).

The power unit 30′ comprises a driving printed circuit board 31′ provided within the housing 21′, a metal core printed circuit board (MCPCB) 32′ provided within the heat dissipation member 23′, and at least one light emitting diode (LED) 33′ provided on the metal core printed circuit board 32′, wherein the driving printed circuit board 31′ is electrically connected with the metal core printed circuit board 32′, the LED 33′ is electrically connected with the metal core printed circuit board 32′, in such a manner that, commercial power input by the lamp cap 10′ (120V 60 Hz in U.S.) is transformed into the working current and voltage of the LED 33′ by the driving printed circuit board 31′, so that the LED 33′ is driven to work, wherein the working voltage of the LED is 3.0-3.8VDC.

Here, the driving printed circuit board 31′ is designed to be a Class 2 isolation driving power. It is worth to mention that, when the power supply of the LED lamp is the Class 2 isolation driving power, the live parts such as LED 33′ are safe low-voltage components. Accordingly, the components, which are capable of being contacted, are isolated low-voltage (namely safe voltage) components even if the LED lamp is damaged.

The LED lamp further comprises a connecting member 50′, the bulb shell 40′ is fittingly and shapedly engaged with the other end of the heat dissipation member 23′ by the connecting member 50′, wherein the bulb shell 40 is made of glass material, the connecting member 50′ can be a sealing ring made of silica gel, also can be made of glue, PC/PBT and other plastic material. Accordingly, the present invention successfully solves the problem of the glass burst caused by different expansion rates while glass combines with metal.

Similarly, both the lamp cap 10′ and the bulb shell 40′ are inherent traditional parts of all LED lamps.

All in all, the present invention has a higher light transmission rate, and is not easy to turn yellow and aging, so that it meets the requirement of the fire-resistant level on the U.S. market. Furthermore, the present invention avoids the glass burst caused by different expansion rates while glass combines with metal, and successfully solves the security problem caused by glass shell burst in the UL impact test.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A light emitting diode (LED) lamp, comprising:
a lamp cap,
a body case, comprising:
a housing, an end portion of which is coaxially provided within said lamp cap,
a housing cover; and
a heat dissipation member, an end of which is connected with said housing cover for forming a whole to be coaxially provided outside said housing and connected with said lamp cap;
a power unit comprising:
a driving printed circuit board provided within said housing and designed to be a Class 2 isolation driving power,
a metal core printed circuit board provided within said heat dissipation member and electrically connected with said driving printed circuit board; and
at least one LED provided on and electrically connected with said metal core printed circuit board, in such a manner that, commercial power input by said lamp cap is transformed into a working current and voltage of said LED by said driving printed circuit board so that said LED is driven to work; and
a bulb shell fittingly and shapedly engaged with the other end of said heat dissipation member.

2. The LED lamp, as recited in claim 1, wherein said heat dissipation member is made of materials with good heat dissipation performance.

3. The LED lamp, as recited in claim 2, wherein said heat dissipation member is made of metal material.

4. The LED lamp, as recited in claim 2, wherein said heat dissipation member is made of plastic material.

5. The LED lamp, as recited in claim 1, wherein said bulb shell is made of metal material.

6. The LED lamp, as recited in claim 2, wherein said bulb shell is made of metal material.

7. The LED lamp, as recited in claim 3, wherein said bulb shell is made of metal material.

8. The LED lamp, as recited in claim 4, wherein said bulb shell is made of metal material.

9. The LED lamp, as recited in claim 1, wherein said bulb shell is made of glass material.

10. The LED lamp, as recited in claim 2, wherein said bulb shell is made of glass material.

11. The LED lamp, as recited in claim 3, wherein said bulb shell is made of glass material.

12. The LED lamp, as recited in claim 4, wherein said bulb shell is made of glass material.

13. The LED lamp, as recited in claim 11, further comprising a connecting member made of glue, wherein said bulb shell is fittingly and shapedly engaged with said other end of said heat dissipation member by said connecting member.

14. The LED lamp, as recited in claim 11, further comprising a connecting member, wherein said bulb shell is fittingly and shapedly engaged with said other end of said heat dissipation member by said connecting member, said connecting member is a sealing ring made of silica gel.

15. The LED lamp, as recited in claim 11, further comprising a connecting member, wherein said bulb shell is fittingly and shapedly engaged with said other end of said heat dissipation member by said connecting member, said connecting member is a sealing ring made of plastic material.
